(19) United States
(12) Patent Application Publication
(10) Pub. No.: US 2008/0291460 A1
(43) Pub. Date: Nov. 27, 2008

(54) Opto-Electronic System and Method for Detecting Perturbations

(76) Inventors: Arkady Khatchaturov, Haifa (IL); Uri Voitsechov, Amirim (IL); Avram Matcovitch, Nesher (IL)

Correspondence Address: Pearl Cohen Zedek Latzer, LLP, 1500 Broadway, 12th Floor, New York, NY, 10036, US

(21) Appl. No.: 12/159,141

(22) PCT Filed: Dec. 28, 2005
(86) PCT No.: PCT/IL2005/001390

§ 371 Date: Jun. 25, 2008

(51) Int. Cl. G01B 9/02

(52) U.S. Cl. 356/478

(57) ABSTRACT

A method for detecting and measuring physical perturbations sensed by a multi-mode waveguide, through which a number of modes of a coherent electromagnetic wave propagates through and exit from. The method comprises irradiating the exiting electromagnetic wave on one or more two-dimensional sensing arrays comprising a plurality of sensing elements that are sensitive to the irradiated electromagnetic wave; determining, simultaneously, in a parallel manner, absolute values of sensed changes across different zones of the two-dimensional sensing arrays, each zone comprising one or more sensing elements; and summing the absolute values of different groups of different zones to obtain a representation of the perturbations.

### FIELD OF THE INVENTION

The present invention relates to sensing device and method. More particularly the present invention relates to modal energy analysis and sensing in fiber optic.

### BACKGROUND OF THE INVENTION

Any internal light propagation within a wave guide (optical fiber) is affected by internal and (mainly) external factors, such as pressure, temperature, bending and, stress. This is always accompanied by changes in the “point” of the exercise power and it propagates along the fibers resulting in a change of the energy distribution among the propagating modes. Energy transition between modes or any local and temporal transient is transformed into an electrical signal after being exposed to a detection circuit.

In the manufacturing and use of optical fibers great attention is given to the modes. There are basically two types of optical fibers: single-mode optical fibers and multi-mode optical fibers. A single mode (SM) optical fiber is a small core optical fiber, through which only one mode (a single electromagnetic wave) propagates. Typically the diameter of SM fibers for 1.5 microns wavelength is in the range of 8-9 microns. A multi-mode (MM) optical fiber allows more than one mode to propagate through the optical fiber. Typically the diameter of a MM optical fiber is 62.5 microns (typical diameters cited from Illustrate Fiber Optic Glossary provided at: http://www.fiber-optics.info/glossary-m.htm).

MM optical fibers are usually used in short transmission distances (such as for local are network—LAN—systems or video surveillance), whereas SM optical fibers are used for longer transmission distances (telephony and multi-channel television broadcast systems).

Using an optical beam for sensing is not new. For example, in U.S. Pat. No. 6,147,787 (Veligdan) discloses a laser microphone for detecting sound pressure waves (see also U.S. Pat. No. 6,014,239). It includes a laser resonator having a laser gain material aligned coaxially between a pair of first and second mirrors for producing a laser beam. A reference cell is disposed between the laser material and one of the mirrors for transmitting a reference portion of the laser beam between the mirrors. A sensing cell is disposed between the laser material and one of the mirrors, and is laterally displaced from the reference cell for transmitting a signal portion of the laser beam, with the sensing cell being open for receiving the sound waves. A photo detector is disposed in optical communication with the first mirror for receiving the laser beam, and produces an acoustic signal there from for the sound waves

Using optical fibers as sensors is also not new. Typically these are sensors of local nature, sensing physical perturbations at an end of the optical fiber, or at a specific location along its length.

However, in U.S. Pat. No. 6,072,921 (Frederick et al.) there was disclosed a fiber-optic acoustical sensor system which includes a light source, an elongate optical cable conducting light from the light source to an optical acoustical transducer located at a distance from the light source along this cable, and a polarizer at the acoustical transducer. The sensor system includes a polarizer providing orthogonally-polarized light along the optical cable to the polarizer located adjacent to the transducer. Because of the polarizer adjacent to the transducer, disturbances of the optical cable and resulting polarization perturbations of the light transmitted along this cable do not affect the optical acoustical transducer. The acoustic transducer is responsive to sound energy to provide an optical return signal indicative of this sound energy. An in-line fiber-optic polarizer suitable for use in this acoustical transducer includes a pair of confronting optical fiber portions aligned along an optical axis and which each define end surfaces disposed at a Brewster polarizer angle with respect to light transmitted along this optical axis. The end surface of one of these optical fibers carries plural alternating sub-layers of high-index and low-index dielectric material, which are effective to p-polarize the transmitted light and substantially eliminate s-polarized light transmission to the optical acoustical transducer.

U.S. Pat. No. 5,218,179 (Carroll) disclosed a method and apparatus for the non-invasive sensing of the pressure within a pipe (or other vessel) using interferometer technique. An optical source produces a first light beam. This first light beam is split between a first (reference) and a second (measurement) optical fiber. The second optical fiber is associated with the pipe such that circumferential displacements in the pipe, due to changes in internal pressure, result in corresponding displacements in the length of the second optical fiber. Length changes in the optical fibers result in variations in the phase of the light emerging there from. The phase difference between the light beams emitted from the first and second optical fibers is then determined and related to changes in the internal pressure of the pipe. See also U.S. Pat. No. 4,994,668 (agakos et al.), U.S. Pat. No. 4,527,749 (Matthews et al.).

U.S. Pat. No. 4,947,693 (Szuchy et al.) disclosed a fiber optic load sensor and method of forming the same for sensing the load applied to a structural surface. The sensor comprises a length of fiber optic material disposed adjacent to the surface. The fiber optic material is connectable to a light source and to a light detector. The fiber optic material includes at least one curved portion deformable in response to the applied load. The curved portion is dimensioned such that the light passing through the fiber optic material is attenuated in linear relation to the deformation of the curved portion in response to the load applied to the surface. See also U.S. Pat. No. 4,734,577 (Szuchy), U.S. Pat. No. 4,692,610 (Szuchy).

U.S. Pat. No. 4,787,741 (Udd et al.) disclosed a fiber optic sensor for sensing environmental effects on counter propagating light beams in an optical loop by comparing the modulation of the light beams in an optical coil exposed to the environmental effects and comparison with a reference fiber shielded from the environmental effects. The counter propagating light paths contain optical phase modulators for creating nonreciprocal phase shifts and may comprise elongated sections forming a long line array.

In U.S. Pat. No. 4,724,316 (Morton) there was disclosed an improved fiber optic sensor of the type in which a fiber optic waveguide component of the sensor is configured to be responsive to an external parameter such that curvature of the fiber optic waveguide is altered in response to forces induced by changes in the external parameter being sensed. The alteration of the curvature of the fiber optic waveguide causes variations in the intensity of light passing there through, these variations being indicative of the state of the external parameter. The improvement comprises coating material covering the exterior portion of the fiber optic waveguide, the coating material having an expansion coefficient and thickness such that distortion of the fiber optic waveguide caused by thermally induced stresses between the coating material and the glass fiber is substantially eliminated. Also disclosed is a support member for supporting the curved fiber optic waveguide, the support member and fiber optic waveguide being configured and arranged to minimize the effects of thermal stress tending to separate the waveguide from the support member.

U.S. Pat. No. 4,589,285 (Savit) disclosed an optical telemetric system for use in a borehole consists of a bidirectional optical fiber to which are coupled a plurality of acousto-optical seismic sensors. The sensors consist of an optical cavity that becomes resonant at certain wavelengths depending upon parameters of cavity length and index of refraction. Those parameters are capable of being modified on the basis of static and dynamic pressure differences within the borehole. A swept-wavelength laser chirp pulse is launched into the bidirectional optical fiber. The static pressure at each sensor establishes a resonant wavelength that serves as a carrier signal. Dynamic pressure changes due to seismic waves modulate the carrier signal. The modulated carrier signals from each sensor are reradiated through the bidirectional optical fiber in a wavelength-division multiplexed format. The multiplexed signals are received by and demultiplexed by a suitable signal receiving apparatus.

An intrusion detection system was disclosed in U.S. Pat. No. 4,538,140 (Prestel) for sensing mechanical and acoustical vibrations, comprises a light source, a fiber optic acoustic transducer, a light intensity to current converter circuit, a display and an audio monitor. The light source is positioned at a point remote from an area to be protected and is coupled to the fiber optic acoustic transducer by a low loss fiber optic transmission line. Similarly, the light intensity to current converter circuit, the display and the audio monitor are located at a point remote from the area to be protected, and are coupled to the fiber optic acoustic transducer by a low loss fiber optic transmission line. When mechanical or acoustical vibrations impinge on the fiber optic acoustic transducer it modulates the intensity of the light beam generated by the light source, thereby causing the system to generate both a visual and audio indication that an intrusion is taking place.

It was suggested to detect electric fields using fiber optics in U.S. Pat. No. 4,477,723 (Carome et al.). The invention disclosed there related to a technique for detecting electric fields by modulating the phase of an optical beam. A length of optical fiber is jacketed with or attached to piezoelectric material that is poled perpendicular to the length of the fiber. An electric field is applied across the piezoelectric element, i.e. in the direction of poling, resulting in a change in the element thickness and a change in the axial dimension, which, in turn, changes the length of the optical fiber. The change in fiber length is accompanied by a smaller change in the refractive index of the fiber. The result is a shift in the optical phase.

A musical instrument using light modulations was disclosed in U.S. Pat. No. 4,442,750 (Bowley). Musical notes and characteristic instrument sounds normally sensed by electromechanical devices such as magnetic pickups and acoustic transducers are generated by the modulation of light within optical fibers and are optically transmitted to amplifying devices without the need for externally mounted sensing devices.

Fiber optic transducers were disclosed in U.S. Pat. No. 4,408,829 (Fitzjerald Jr. et al.). It deals with method and apparatus for detecting and converting pressure signals to modulated light signals by micro-bending optical fibers as a function of the pressure signals. Transducers are described which include a length of multimode optical fiber supported at spaced points across a flexible diaphragm. Movement of the diaphragm in response to the pressure signals micro-bends the optical fiber to induce attenuation of light traveling along the fiber as a function of the signals.

Another fiber optic sensor was disclosed in U.S. Pat. No. 4,408,495 (Couch et al.). A system for monitoring vibration or mechanical motion of equipment utilizing an optical waveguide sensor coupled to the equipment. The optical waveguide sensor is formed into a coil or a sinuous path, which exceeds the bend radius, or critical angle for internally reflected light directed through the waveguide. Vibration or mechanical force imparted to the waveguide from the equipment being monitored further alters the bending losses in the waveguide, and this change in bending losses is used to generate a signal as a function of the vibration or mechanical force.

In U.S. Pat. No. 5,405,198 (Taylor) there was disclosed an optical technique for detecting acoustic waves of selected frequency and determining their angle of arrival in a medium such as water. The technique utilizes one or more lengths of single mode optical fiber having a birefringence whose orthogonal axes are helically disposed throughout the length of the fiber at a predetermined uniform pitch. Sound pressure waves of certain frequencies incident upon the fiber throughout its length change its birefringence which affects the relative phase of polarized light components propagating from one end to the other by an amount proportional to the amplitude of the acoustic wave. The twisted optical fiber may be arranged in parallel with other like fibers and axes twisted at different pitches thereby enabling detection of sound waves over a range of frequencies and their angles of incidence.

Yet another fiber optic sensor was disclosed in U.S. Pat. No. 4,375,680 (Cahill et al.). A light source is operated near its threshold and its output is split and sent in opposite direction about a fiber optic coil which is exposed to acoustic energy. The recombined light out of the coil is modulated at acoustic frequency. The modulated light can be fed back to the light source which responds to the modulation with large amplitude variations which are sent to a detector for conversion into an electrical signal representative of the acoustic energy. Alternatively, the light beam may be directed from the fiber coil to the detector directly. The sensors can include components for rejecting noise at frequencies not of interest and a plurality of similar sensors can be formed in an array to obtain directional information or increased sensitivity.

U.S. Pat. No. 4,363,114 (Bucaro et al.) disclosed an optical system for frequency-modulation heterodyne detection of an acoustic pressure wave signal. An optical beam is directed into a Bragg cell outside of the fluid medium in which acoustic signals are to be detected. The Bragg cell modulates the incident beam such that two beams of different frequency exit the cell. The two beams are directed into an input optical fiber and the resultant combined beam is transmitted over a desired distance to a fiber optic transducer disposed in the fluid medium. The transducer includes two coiled optical fibers, a reference fiber and a signal fiber, each of which has a different sensitivity to incident acoustic pressure wave signals. The transmitted beam is directed from the input optical fiber through a power divider which splits the beam into two equal parts, one part passing through the reference fiber, the other part passing through the signal fiber. A filter in the signal fiber transmits only a fraction of the light at one of the two frequencies. The two parts of the split beam exiting the coiled optical fibers are coupled into another optical fiber and transmitted to a photo-detector from which the output signal is processed to indicate the detection of an acoustic pressure wave signal. In a modification of the system, different polarization states are imparted with a polarizer and a half-wave retardation plate to the two beams of different frequency produced by the Bragg cell. The power divider and filter are replaced by a polarization beam splitter and another half-wave plate. See also U.S. Pat. No. 4,297,887 (Bucaro) and U.S. Pat. No. 4,238,856 (Bucaro et al.).

Analyzing information retrieved from fiber optic sensors is also not new, and some analyzing techniques are also mentioned hereinabove. For example wave-front analysis is mainly a static oriented beam analysis, dealing with the power distribution of any beam. The aim of wave-front analysis is to provide beam quality analysis, and to serve as a feedback method for beam correction or for adaptation of the beam to a specific pattern U.S. Pat. No. 4,863,270 (Spillman, Jr. et al) discloses analysis of a signal retrieved from a multi-mode optical fiber sensor, and acquired by a CCD.

An object of the present invention is to provide a sensing device comprising an optical fiber, that can detects and sense physical perturbations throughout its length, rather than on an end or at a local position, and an analysis method for analyzing the signal retrieved from the sensing device.

Another object of the present invention is to provide such sensing device that is not limited to a particular acquiring technology (unlike Spillman's patent which is CCD-based).

Spillman's technology is limited to frame-to-frame time differentiation only. This makes his device slow in response (substantially bandwidth limited). In practice his device is limited to changes not faster than half of frame rate. Frame-to-frame differentiation requires handling information on a frame-base. It is an object of the present invention to provide individual-sensing-element processing, as would be disclosed hereinafter

In a preferred embodiment of the present invention it is aimed at providing a sensing system for detecting a signal relating to physical changes picked up by an electromagnetic radiation passing through an optical fiber, and analyzing that signal (see US 20050131289, whose assignee is same as of the present invention).

### SUMMARY OF THE INVENTION

There is thus provided, in accordance with some preferred embodiments of the present invention, a method for detecting and measuring physical perturbations sensed by a multi-mode waveguide, through which a number of modes of a coherent electromagnetic wave propagates through and exit from, the method comprising:

irradiating the exiting electromagnetic wave on at least one two-dimensional sensing array comprising a plurality of sensing elements that are sensitive to the irradiated electromagnetic wave;

determining, simultaneously, in a parallel manner, absolute values of sensed changes across different zones of said at least one two-dimensional sensing array, each zone comprising one or more sensing elements; and

summing the absolute values of different groups of different zones to obtain a representation of the perturbations.

Furthermore, in accordance with some preferred embodiments of the present invention, said at least one sensing array comprises a single sensing array, and wherein the different zones are on the single sensing array.

Furthermore, in accordance with some preferred embodiments of the present invention, the number of zones substantially matches to the number of modes.

Furthermore, in accordance with some preferred embodiments of the present invention, the method comprises:

splitting the exiting electromagnetic wave into at least two arms to obtain different path lengths;

irradiating the arms on different groups of sensing zones; and

comparing the sums of absolute values of sensed changes across said different groups.

Furthermore, in accordance with some preferred embodiments of the present invention, the method comprises:

splitting the exiting electromagnetic wave into at least two arms to obtain different path lengths;

irradiating, while preserving geometrical similitude, the arms on different groups of sensing zones; and

summing the absolute values of subtractions between pairs of corresponding zones of the different groups.

Furthermore, in accordance with some preferred embodiments of the present invention, the waveguide comprises an optical fiber.

Furthermore, in accordance with some preferred embodiments of the present invention, said at least one sensing array comprises an array of photo-sensing elements.

Furthermore, in accordance with some preferred embodiments of the present invention, the photo-sensing elements are selected from a group containing: photo-diodes, photo-multipliers.

Furthermore, in accordance with some preferred embodiments of the present invention, the method further comprises shaping the exiting electromagnetic wave and spatially filtering it.

Furthermore, in accordance with some preferred embodiments of the present invention, there is provided a device for detecting and measuring physical perturbations sensed by a multi-mode waveguide, through which a number of modes of a coherent electromagnetic wave propagates through and exit from, the device comprising:

at least one two-dimensional sensing array comprising a plurality of sensing elements that are sensitive to the electromagnetic wave, for irradiating the exiting modes of the electromagnetic wave on; and

at least one processor for determining, simultaneously, in a parallel manner, absolute values of sensed changes across different zones of said at least one two-dimensional sensing array, each zone comprising one or more sensing elements, and for summing the absolute values of different groups of different zones to obtain a representation of the perturbations.

Furthermore, in accordance with some preferred embodiments of the present invention, said at least one sensing array comprises a single sensing array, and wherein the different zones are on the single sensing array.

Furthermore, in accordance with some preferred embodiments of the present invention, the number of zones substantially matches to the number of modes.

Furthermore, in accordance with some preferred embodiments of the present invention, the device further comprises a splitter for splitting the exiting electromagnetic wave into at least two arms to obtain different path lengths.

Furthermore, in accordance with some preferred embodiments of the present invention, the waveguide comprises an optical fiber.

Furthermore, in accordance with some preferred embodiments of the present invention, said at least one sensing array comprises an array of photo-sensing elements.

Furthermore, in accordance with some preferred embodiments of the present invention, the photo-sensing elements are selected from a group containing: photo-diodes, photo-multipliers.

Furthermore, in accordance with some preferred embodiments of the present invention, the device further comprises at least one optical element for shaping the exiting electromagnetic wave and spatially filtering it.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates energy exchange between modes of an optical wave propagating through an optical fiber.

FIG. 2 illustrates an opto-electronical device for detecting perturbations in accordance with a preferred embodiment of the present invention, which works on time-based differentiation.

FIG. 3 schematically illustrates an algorithm for detecting perturbations according to a preferred embodiment of the present invention, which is used in conjunction with the opto-electronical device for detecting perturbations shown in FIG. 2.

FIG. 4 illustrates an opto-electronical device for detecting perturbations in accordance with another preferred embodiment of the present invention, splitting the output signal from the optical fiber into two beams, to produce different optical path lengths, allowing for spatial differentiation.

FIG. 5 illustrates an opto-electronical device for detecting perturbations in accordance with yet another preferred embodiment of the present invention, splitting the output signal from the optical fiber into two beams of different optical path lengths and yet optically identical, allowing for spatial differentiation, comparing between corresponding sensing elements of the two arrays.

### DETAILED DESCRIPTION OF PREFERRED EMBODIMENTS

The present invention proposes a method and a system for fast detection of mechanical perturbations experienced anywhere along an optical fiber (or other waveguide). These perturbations affect an electromagnetic wave as it passes through the optical fiber. It is based on inter-modal energy transfer and it allows for a “continuous detection path” (any point along the fiber) with an equal sensitivity.

The present invention, although not limited to the type of optical fibers, only, seems in particular useful when using MM (multi-modal) fiber optic.

A main aspect of the present invention is the provision of a MM fiber optic through which an optical beam featuring a plurality of modes propagates.

In principle a method is disclosed herein for detecting and measuring physical perturbations sensed by a multi-mode waveguide, through which a number of modes of a coherent electromagnetic wave propagates through and exits from. The method comprises irradiating the exiting modes of the electromagnetic wave on one (or two or more) two-dimensional sensing array comprising a plurality of sensing elements that are sensitive to the irradiated electromagnetic wave; determining, simultaneously, in a parallel manner, absolute values of sensed changes across different zones of the two-dimensional sensing array (or arrays), each zone comprising one or more sensing elements; and summing the absolute values to obtain a representation of the perturbations.

The present invention is based on the realization that when a optical beam passes through a MM fiber optic, a beam incorporating a plurality of modes emerges from that fiber, the various modes represented in the form of light spots (speckles) distributed across an image of the beam projected on a screen or other surface. When subjecting the fiber optic to external physical perturbations, such as pressure, stress, temperature, bending, and other such perturbations, intermodal energy transfer is stimulated, causing the light spots representing the various modes to be affected in intensity and position until the disturbance ceases.

Another aspect of the present invention is the provision of a fast photo-detection array, comprising an array of photo detectors, onto which the output light of the fiber optic is directed (preferably subjected to beam optical expansion). A preferred embodiment for the fast photo-detection array may comprise an array of photosensitive diodes. The fast photo detection array provides the system with a good sensitivity and enables high frequencies to be used, as will be explained hereinafter.

The fast photo-detection array is connected through some electronic pre-processing to an acquisition device, where the signals obtained and analyzed.

The present invention introduces a novel method of detecting these intensity and position changes.

The present invention offers many advantages, which will become apparent after reading the detailed description of the invention and considering the accompanying figures. An important advantage of the disclosed invention is the use of a fiber optic whose entire length is utilized as an effective sensing device. Another advantage is that the disclosed sensing device offers a wide-range detection, theoretically unlimited, when compared to the limitations by the physical properties of the equipment used (the cells of the photo-detection array and electronics). The sensing device of the present invention offers very high sensitivity, as mode-energy transfer of the optical wave propagating through the optical fiber is capable of detecting even the faintest disturbance impact on the optical fiber. The mode-energy transfer is representing changes in the various optical parameters: amplitude, phase and polarization.

The device and method of the present invention present a relatively low-cost yet highly sensitive and broad-band sensing system. It lends itself easily to miniaturization and hybridization (offering multiple configurations).

The sensing device and method of the present invention may be passive in its nature and miniature in dimensions (the only exposed element being the fiber optic), thus facilitating the installation of a sensing or detection system that is hard to reveal.

Alternatively the system may be active for induced event generation.

The sensing device and method of the present invention can operate in very demanding environments, as it is immune to electromagnetic or radiofrequency radiation, or electrical discharges.

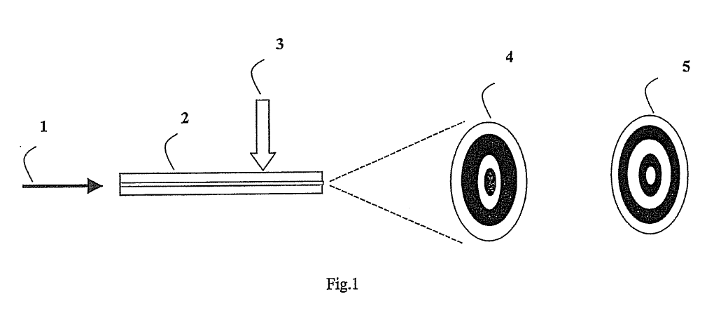

The disclosed system and method are based on a known phenomenon, which uses multi-mode optic fibers as sensors for detecting different physical perturbations. This principle is illustrated in FIG. 1. A light source (1), for example a laser or a laser diode, is used to generate coherent, monochromatic radiation into a multi-mode optic fiber (2). The optical fiber segment (2) has a core sufficiently large to accommodate the lowest order and at least one higher order mode and thus functions as a multi-mode fiber with the different modes constructively and destructively interfering to form a complex interference pattern. The output radiation from the optical fiber segment, when projected onto a two-dimensional surface, shows a characteristic “speckle” pattern. (4). When any segment of the optic fiber is subjected to a temporary disturbance or perturbation (3), the optical path length of each mode changes, which results in a change in the interference pattern, creating a different “speckle pattern” (5). The changes in the speckle pattern are analyzed, to provide information that is functionally related to the perturbation. The perturbations can take the form of compressive strain, tensile strain, or a combination thereof caused by bending of the fiber or as a result of a change in environmental temperature or pressure.

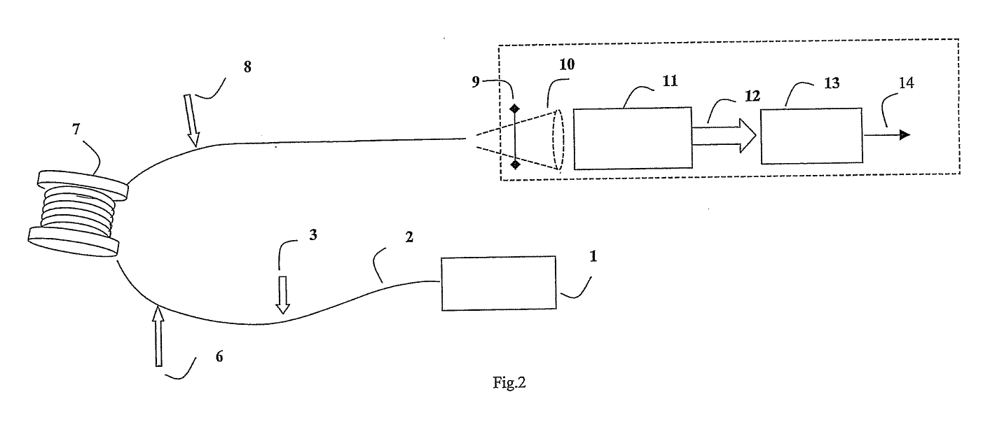

Based on the above-described principle, a novel method and system are disclosed. FIG. 2 illustrates an opto-electronical device for detecting perturbations in accordance with a preferred embodiment of the present invention, which works on time-based differentiation of the output signal. A light source (1), for example a laser source or a laser diode, is used to output a coherent, monochromatic radiation into a multi-mode optical fiber (2). The optical fiber (2) is optionally a part of a spool of fiber (7). When a coherent light propagates through an optical multimode fiber, a speckle pattern can be observed as a result of interference between different propagation modes. Because a speckle pattern is caused by variations in the phase of the fiber modes along a fiber, any stress applied to the fiber results in instantaneous changing of the speckle pattern.

FIG. 2 illustrates detection of three different events within the disclosed system (3, 6 and 8 in FIG. 2). There may be various kinds of physical influences on the optical fiber, some of which are shown in this figure. These include, for example, internal dislocation, or irregularities in the optical fiber internal structure, external pressure, caused by vibration, changes in pressure, temperature, or other mechanical influences.

The output of the optic fiber (2), preferably undergoes optical treatment (9) in the form of beam shaping and/or spatial filter and is irradiated (10) onto photo-detection array (11), comprising an array of photo-sensors. The electronic signal (12) generated by the photo-detection array is processed by processor (13), and an output signal (14) is generated. The photo-detector array is a matrix of individually parallel accessible and processible photo-sensing elements. By the phrase “individually parallel accessible and processible” it is meant that all or some of the sensing elements may be simultaneously sensed and processed.

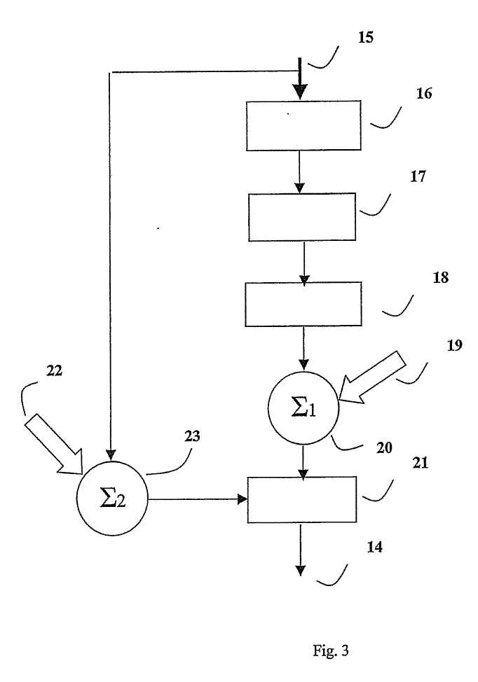

Processing of the signal generated by the photo-detection array shown in FIG. 2 is described in FIG. 3. According to a preferred embodiment of the present invention, the signal (15) from each sensor element of the array is preferably pre-processed (16) (analog amplifying and filtering), and a time-derivative (17) is obtained, by passing the pre-processed signal through a high-pass filter. Then, absolute value (18) is calculated. The obtained value (18) is summing (20) with all (19) corresponding to the other sensor elements undergo absolute derivation. The result is preferably normalized (21) by a divider to the total intensity irradiated on the array, obtained as the sum (23) of (15) and signals from all the other sensing elements (22). The result is output signal (14).

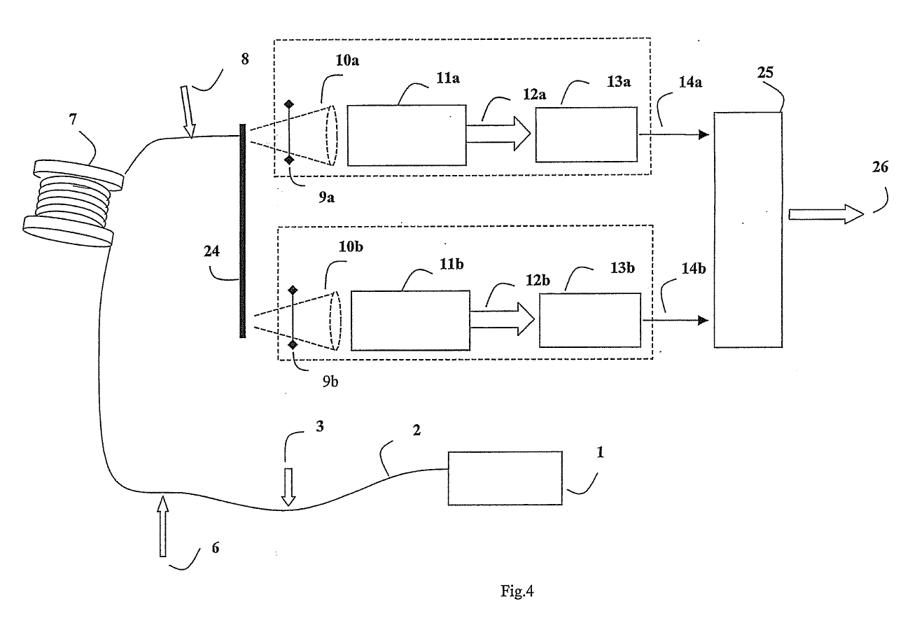

FIG. 4 illustrates an opto-electronical device for detecting perturbations in accordance with another preferred embodiment of the present invention, splitting the output beam from the optical fiber into two a and b beams (arms), to produce different optical path lengths, allowing for spatial differentiation.

In splitting the output beam one must ensure that both split arms preserve the polarization and the phase of the output beam.

Because of the difference between the propagation constants of different modes, two speckle patterns can be distinguished when one of them is spatially shifted in the direction of the propagation of the beam. If for a given spatial shift distance any fiber-mode phase changes to π, it is just a mode that makes a maximum contribution to the difference between two speckle patterns. This way it is possible to separate signals carried by different fiber modes by varying the spatial shift distance in accordance with following relationship.

L·Δβ=π·k

Here L is the shift distance, Δβ is the difference between fiber mode propagation constant and k is the integer.

The utilization of changes in the speckle patterns as a function of the distance L enables fiber-modes optical pre-filtering, yet another novel feature, which is not disclosed in prior art.

Each arm of the splitted beam is preferably shaped or filtered (or both) (9a, 9b) and irradiated (10a, 10b) onto a photo-detector array (11a, 11b, respectively). The signals (12a,12b) generated from the photo-detector arrays are processed by processors (13a, 13b) and the processed signals (14a, 14b) emerge as two output signals and are entered into comparator (25), which compares between the two signals (differentiates them) and generates an output signal (26) that represents the differentiation. In the design of the apparatus depicted in FIG. 4 special care is taken to make sure that the optical path of the one split beam differs in distance from the optical path of the other split beam, so that the split beams are processed in a parallel manner simultaneously, but with a shift in the optical path length.

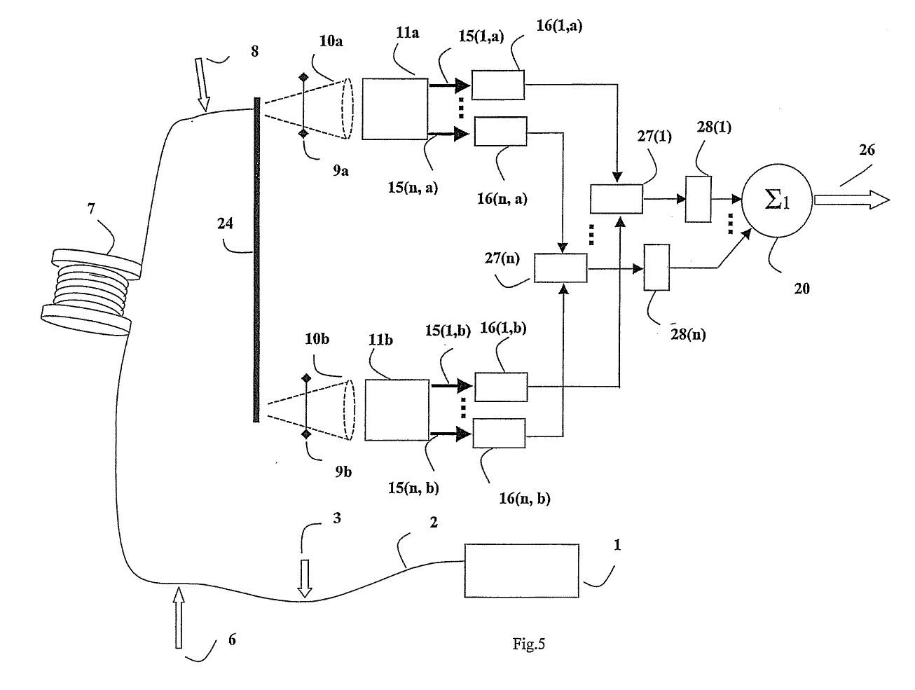

FIG. 5 illustrates an opto-electronical device for detecting perturbations in accordance with yet another preferred embodiment of the present invention, splitting the output signal from the optical fiber into two beams of different optical path lengths and yet optically identical, allowing for spatial differentiation, comparing between corresponding sensing elements of the two arrays.

The signals (15(1,a) to 15(n,a)) and (15(1,b) to 15(n,b)) from pairs of corresponding sensors of the two photo-detector arrays are preferably subjected to analog pre-processing (16(1,a) to 16(n,a)) and (16(1,b) to 16(n,b)) respectively.

The spatial derivative of each corresponding pairs of sensing elements (27(1) to 27(n)) is obtained, and the absolute value (28(1) to 28(n)) is extracted. All absolute values of the spatial derivatives of all corresponding pairs of sensors are summed up (20) to produce the final output signal (26).

In a preferred embodiment of the invention, the photo detector array (11), is implemented by using independent detectors, such as an array of photo-diodes, thus enabling parallel processing of the image acquired. The parallel processing of the signals from the photosensitive elements is free of frame rate limitations. The only limitation may relate to the implementation (many diodes or a big array of photodiodes) due to individual diode performance and budget limitations. This is contrary to other applications such as described in U.S. Pat. No. 4,863,270 that uses a CCD detector, which is frame rate limited. A detector array based on a CCD requires serial processing of the sensing array pixels, resulting in frequency bandwidth limitation. This is because a time-derivative of any pixel signal can be achieved only by all frame-to-frame comparison. Denoting by N the number of pixels, and by τ the time required for a single pixel readout procedure, the bandwidth limitation for a CCD can be estimated as follows:

$${f}_{max} = \frac{1}{2 N τ}$$

In other words only N pixels are available for serial processing, when operating in a high frequency. For example for given fₘₐₓ=50 μMHz and even for τ=3 ns

N=(2fₘₐₓτ)⁻¹≈3

The proposed alternative, parallel processing of a sensing array, as disclosed herein, is free of this limitation, as all sensing elements are processed in parallel. Thus the number of pixels is limited only by considerations related to the noise level of the single-element detector.

In another preferred embodiment of the invention a method for optimally selecting the number of photo-diodes (pixels) for the photo-detector array is disclosed. The number of pixels (N) is selected, in order to reduce to a minimum the number of sensors without compromising performance i.e. without loosing sensitivity. The motivation behind the optimization is to reduce the price of the photo-detector array, which is expensive. The optimization is performed by considering the number of modes (M) in the fiber optic used. More specifically, for any given number of pixels N there is an optimal amount of fiber modes M, which provide maximum sensitivity. The table below presents the sensitivity obtained by using different pairs of M and N. As seen from the Table 1, the maximum sensitivity is obtained when M and N are approximately equal—M≈N. Thus, when using a MM optic fiber with 16 modes, one can use only 16 detectors without compromising the system's sensitivity.

| | N = 1 | N = 4 | N = 16 | N = 32 | N = 64 | N = 128 | N = 256 | N Infinity |
|---|---|---|---|---|---|---|---|---|
| M = 1 | 1 | 1 | 1 | 1 | 1 | 1 | 1 | 1 |
| | 0.57735 | 3.265986 | | | | | | |
| M = 10 | | | 3.162278 | 3.162278 | 3.162278 | 3.162278 | 3.162278 | 3.162278 |
| | 0.102669 | 0.580784 | 3.285408 | 7.814062 | | | | |
| M = 50 | | | | 7.071068 | 7.071068 | 7.071068 | 7.071068 | 7.071068 |
| | 0.030705 | 0.173695 | 0.982566 | 2.33695 | 5.558234 | | | |
| M = 100 | | | | | 10 | 10 | 10 | 10 |
| | 0.018257 | 0.10328 | 0.584237 | 1.389559 | 3.304946 | 7.86053 | | |
| M = 1000 | | | | | | | | 31.62278 |
| | 0.003247 | 0.018366 | 0.103894 | 0.247102 | 0.587712 | 1.397822 | 3.324599 | |

For a given number of pixels N to modify the number of fiber-modes M is possible by choosing single-mode fiber core diameter and light wavelength, as it follows from the table below.

NA = 0.12

| Wavelength | | 9 μm core | 20 μm core | 50 μm core fiber |
|---|---|---|---|---|
| 0.532 | μm | 20.33733 | 100.4313 | 627.6955 |
| 1 | μm | 5.755953 | 28.42446 | 177.6529 |
| 1.3 | μm | 3.405890 | 16.81921 | 105.1200 |
| 1.5 | μm | 2.558201 | 12.63309 | 78.95684 |

While the above discussion refers to the relation between the number of modes and the number of pixels (sensing elements), one can combine several physical sensing elements to define a sensing zone, and relate to that zone as a sensing unit. This may be desired when attempting to match the dimensions of speckles with the dimension of the sensing zone.

It is noted that while some of the embodiments shown in the accompanying figures include two sensing arrays, one can use a single sensing array and divide it into two adjacent groups of sensing zones, and treat these groups as different sensing arrays.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method for detecting and measuring physical perturbations sensed by a multi-mode waveguide, through which a number of modes of a coherent electromagnetic wave propagates through and exit from, the method comprising:
irradiating the exiting electromagnetic wave on at least one two-dimensional sensing array comprising a plurality of sensing elements that are sensitive to the irradiated electromagnetic wave;
determining, simultaneously, in a parallel manner, absolute values of sensed changes across different zones of said at least one two-dimensional sensing array, each zone comprising one or more sensing elements; and
summing the absolute values of different groups of different zones to obtain a representation of the perturbations.

2. The method of claim 1, wherein said at least one sensing array comprises a single sensing array, and wherein the different zones are on the single sensing array.

3. The method of claim 1, wherein the number of zones substantially matches to the number of modes.

4. The method of claim 1, comprising:
splitting the exiting electromagnetic wave into at least two arms to obtain different path lengths;
irradiating the arms on different groups of sensing zones; and
comparing the sums of absolute values of sensed changes across said different groups.

5. The method of claim 1, comprising:
splitting the exiting electromagnetic wave into at least two arms to obtain different path lengths;
irradiating, while preserving geometrical similitude, the arms on different groups of sensing zones; and
summing the absolute values of subtractions between pairs of corresponding zones of the different groups.

6. The method of claim 1, wherein the waveguide comprises an optical fiber.

7. The method of claim 6, wherein said at least one sensing array comprises an array of photo-sensing elements.

8. The method of claim 7, wherein the photo-sensing elements are selected from a group containing: photo-diodes, photo-multipliers.

9. The method of claim 6, further comprising shaping the exiting electromagnetic wave and spatially filtering it.

10. A device for detecting and measuring physical perturbations sensed by a multi-mode waveguide, through which a number of modes of a coherent electromagnetic wave propagates through and exit from, the device comprising:
at least one two-dimensional sensing array comprising a plurality of sensing elements that are sensitive to the electromagnetic wave, for irradiating the exiting modes of the electromagnetic wave on; and
at least one processor for determining, simultaneously, in a parallel manner, absolute values of sensed changes across different zones of said at least one two-dimensional sensing array, each zone comprising one or more sensing elements, and for summing the absolute values of different groups of different zones to obtain a representation of the perturbations.

11. The device of claim 10, wherein said at least one sensing array comprises a single sensing array, and wherein the different zones are on the single sensing array.

12. The device of claim 10, wherein the number of zones substantially matches to the number of modes.

13. The device of claim 10, further comprising:
a splitter for splitting the exiting electromagnetic wave into at least two arms to obtain different path lengths.

14. The device of claim 10, wherein the waveguide comprises an optical fiber.

15. The device of claim 10, wherein said at least one sensing array comprises an array of photo-sensing elements.

16. The device of claim 15, wherein the photo-sensing elements are selected from a group containing: photo-diodes, photo-multipliers.

17. The device of claim 15, further comprising at least one optical element for shaping the exiting electromagnetic wave and spatially filtering it.
